(19) United States
(12) Patent Application Publication
(10) Pub. No.: US 2022/0305500 A1
(43) Pub. Date: Sep. 29, 2022

(54) PARTICLE REMOVAL APPARATUS AND METHOD

(71) Applicant: Romar International Limited, Newburgh (GB)

(72) Inventor: Robert NOBLE, Peterhead (GB)

(73) Assignee: Romar International Limited, Newburgh (GB)

(21) Appl. No.: 17/842,182

(22) Filed: Jun. 16, 2022

Related U.S. Application Data
(63) Continuation of application No. 16/614,856, filed on Nov. 19, 2019, now abandoned.

(30) Foreign Application Priority Data
May 19, 2017 (GB) 1708078.9

(51) Int. Cl. B03C 1/28; B01D 21/00; C02F 1/48; E21B 21/06

(52) U.S. Cl. CPC B03C 1/288; B01D 21/0009; C02F 1/485; E21B 21/065; B03C 2201/18; C02F 2101/203

(57) ABSTRACT

Some described examples relate to an apparatus for removing magnetically active particles from a fluid. The apparatus comprises at least one vessel for receiving a fluid comprising magnetically active or ferrous particles, and at least one electromagnet operable to produce a magnetic field within the vessel to act on the magnetically active or ferrous particles in use.

### CROSS-REFERENCE TO RELATED APPLICATION

This is a continuation of U.S. application Ser. No. 16/614,856, filed Nov. 19, 2019, which is a national phase under 35 U.S.C. 371 of PCT International Application No. PCT/GB2018/051365 which has an International filing date of May 21, 2018 and which claims priority to United Kingdom Application No. 1708078.9, filed on May 19, 2017, the disclosures of each of which are hereby incorporated by reference in their entirety.

### FIELD

Some examples relate to an apparatus for removing particles from a fluid.

### BACKGROUND

In the oil and gas industry, wells are drilled to gain access to underground hydrocarbon reserves. Once drilled, hydrocarbons can be produced from a well for many years.

Oil and gas wells usually have their bore holes lined with steel pipes, referred to normally as casing. In mature wells, when oil or gas production drops below economic production levels, it is often useful to reutilise at least part of said bore hole. To be able to do this, one method is to remove the casing completely. It is often more cost effective to simply drill the pipeline out, or at least to drill a window in the pipeline. The window can then be used to allow a drilling assembly to exit the bore hole and reach a new part of the reservoir.

Such a method produces large quantities of steel swarf derived primarily from the pipeline. The swarf is mixed with large quantities of mud during the drilling process either from the bore hole or from its introduction as a lubricant. Typically, the mud/swarf mixture will comprise a sufficient quantity of water to enable the mixture to flow.

Due to the high steel content of the mud when it exits the bore hole and its potential hazard, in part due to the sharpness of the metal slivers it contains, disposal or re-use of the mud can be problematic. One method of decontamination is simply to remove excess water from the mixture and separate the larger swarf pieces by hand. This is obviously a time consuming and potentially dangerous mode of separation. Decommissioning or abandonment may be necessary when the well is no longer economic or below economic production levels. In this case large sections of the casing may be milled to allow a barrier to be put in place, usually referred to as a CMT Barrier.

### SUMMARY

A first aspect relates to an apparatus for removing magnetically active or ferrous particles from a fluid, the apparatus comprising:
at least one vessel for receiving a fluid comprising magnetically active or ferrous particles; and
at least one electromagnet operable to produce a magnetic field within the vessel to act on the magnetically active or ferrous particles in use.

A further aspect relates to an apparatus for removing magnetically active particles from a fluid, the apparatus comprising:
at least one vessel for receiving a fluid comprising magnetically active or ferrous particles; and
at least one electromagnet operable to produce a magnetic field within the vessel to act on the magnetically active or ferrous particles in use;
   wherein the at least one vessel is removable from the apparatus.

The electromagnet may be operable to produce the magnetic field so as to attract and/or repel the magnetically active or ferrous particles in use. The electromagnet may be operable to produce the magnetic field so as to capture at least some or all of the magnetically active or ferrous particles in the magnetic field in use.

The vessel may comprise one or more fluid ports. The apparatus may be configured such that the fluid is received into the vessel via at least one of the fluid ports, such as a fluid inlet. The apparatus may be configured such that the fluid is expelled from the vessel through at least one of the fluid ports, such as a fluid outlet.

The vessel may be configured or configurable to receive the fluid having a first concentration of magnetically active or ferrous particles via at least one of the fluid ports, e.g. the fluid inlet. The vessel may be configured or configurable to expel the fluid having a second concentration of magnetically active or ferrous particles via at least one of the fluid ports, e.g. the fluid outlet. The apparatus may be configured or configurable such that at least some or all of the magnetically active or ferrous particles in the fluid are retained in the vessel, e.g. under the action of the magnetic field. As such, the second concentration of magnetic particles may be lower than the first concentration.

In use, operation of the electromagnet provides a magnetic field, which may facilitate the removal of magnetic particles from a fluid received by the vessel, e.g. by capturing, attracting or repelling magnetic particles using the magnetic field and may retain the particles in the vessel. The fluid may be unaffected by the magnetic field and may be expelled from the vessel. In this way, the fluid may be received having a first higher concentration of magnetic particles and may exit the vessel having a second lower concentration of magnetic particles.

At least part (e.g. a removable part) or all of the vessel may be removable from the apparatus. Removal of the vessel or the removable part of the vessel may facilitate removal of magnetic particles from the vessel. Once removed from the apparatus, the vessel or the removable part may be reoriented, e.g. tipped or turned, to facilitate easier cleaning of the vessel. In one example, the polarity of the electromagnet may be switched to assist with the cleaning of the vessel, by assisting to repel, or reduce the magnetic attraction of the particles to the apparatus. Cleaning of the vessel may be, for example, manual, mechanised, chemical etc.

The electromagnet may be configured or configurable to act on, e.g. to attract or repel, the magnetically active or ferrous particles towards a section of the vessel, in use. The vessel may be configured to retain the magnetic particles in the section of the vessel. The section of the vessel may comprise, for example, one side of the vessel e.g. the side of the vessel furthest from the fluid outlet. The section of the vessel may comprise or be comprised in a basket or other container, which may be configured to collect the magnetically active or ferrous particles. The section of the vessel may be or comprise or be comprised in the removable part. Such retention of magnetic particles may ultimately facilitate removal of the particles from the vessel, may produce a preferable weight distribution of particles in the vessel, may facilitate cleaning of the vessel, or the like.

The apparatus may be configured or configurable to hold the fluid in the vessel for a specific residence time e.g. 10 minutes, 15 minutes, 20 minutes or the like. During this residence time, the magnetic particles in the fluid may become captured by the magnetic field, and/or be retained in the vessel, even once the remainder of the fluid is drained therefrom. The residence time of the fluid may be selected or selectable, e.g. such that use of the electromagnet is minimised, and the percentage of magnetic particles captured by the magnetic field is maximised. In this way, the energy efficiency of the apparatus may be increased, parts may wear-out less easily, resulting in the replacement of fewer parts, etc.

The apparatus may be located near and/or be connected or connectable to a wellbore, for example an oil and gas wellbore. The fluid may be or comprise a fluid removed from the wellbore, e.g. from drilling a pre-existing wellbore. The fluid may comprise at least one of: drilling mud, water and/or other wellbore fluids. The magnetically active or ferrous particles may be or comprise at least one of: drill swarf, steel and/or debris from a pipe, tubular, wellbore casing and/or other metallic wellbore component or content.

The apparatus may be connected or connectable to, and/or supplied with the fluid via, a pipe, or a network and/or system of pipework e.g. a branched system of pipework. The apparatus may comprise or be comprised in at least part of the network and/or system of pipework.

The apparatus may deliver the fluid from the vessel via a pipe, or a network and/or system of pipework e.g. a branched system of pipework.

The vessel or the removable part of the vessel may be removable from the apparatus by lifting the vessel or the removable part of the vessel from the apparatus. The vessel may comprise a lifting attachment to facilitate lifting of the vessel or the removable part of the vessel. For example, the vessel or the removable part of the vessel may comprise a hook, a flange, a lip, or the like. The vessel or the removable part may be liftable into and out of position through use of lifting device such as a crane, for example.

The apparatus may comprise, or be able to be used in combination with, multiple vessels. In one example, two or more or each of the vessels may have a common or standard form, e.g. such that multiple similar or identical vessels may be readily produced. The multiple vessels may be used in combination with one apparatus, for example several of the multiple vessels may be in use at any one time, and/or one vessel may be swapped out for another vessel. In this way a first vessel, once full, may be removed and immediately replaced with a waiting empty vessel, rather than requiring the cleaning/emptying and replacement of the original vessel: a slower process. Such a standard form of vessel may be, for example, a hollow cuboid or other prismatic shape.

The apparatus may comprise at least two vessels. Each of the at least two vessels may be operated by a separate electromagnet. As such, each of the at least two vessels may be filled/emptied separately. In one example, where there is a large influx of fluid to the apparatus, both vessels may be filled and electromagnets operated at the same time. Alternatively, each electromagnet may be operated alternately such that one vessel may be emptied and/or cleaned of magnetically active or ferrous particles while the at least one other vessel is filled with fluid. Having at least two vessels may provide the apparatus with a degree of redundancy, such that normal operation of the apparatus may be maintained even in the event of a component of the apparatus becoming non-functional.

Each of the two vessels may be operated by the same electromagnet. In doing so, the complexity of the apparatus may be reduced.

The at least two vessels may be located side-by-side. Side-by-side vessels may provide the benefit of simplifying the design of the apparatus, for example by requiring less extensive pipework.

The at least two vessels may be located at the same vertical elevation. The at least two vessels may be located at a differing vertical elevation.

Flow of the fluid via the at least one fluid port may be controlled by a valve. A valve may be positioned adjacent the at least one fluid port, e.g. immediately upstream of the fluid inlet, and/or immediately downstream of the fluid outlet. An inlet valve may be provided adjacent the fluid inlet, and an outlet valve may be provided adjacent the fluid outlet. The valve may permit the selective inflow or outflow of fluid to/from the vessel.

Where the apparatus comprises multiple vessels comprising multiple fluid ports, multiple valves may be positioned adjacent each at least one fluid port of each vessel. Multiple valves may permit the selective filling of one or more of the multiple vessels.

The apparatus may comprise a control unit. The control unit may be electrically operated. The control unit may be able to alert a user to the need to take an action, for example open/close a valve, remove a vessel from the apparatus, operate an electromagnet, or the like. The control unit may be able to autonomously control the apparatus, for example, by opening/closing a valve (e.g. the inlet valve and/or the outlet valve), removing a vessel from the apparatus, operating an electromagnet, or the like.

The control unit may comprise a sensor. The sensor may be used to detect various parameters, such as the volume of liquid held by the vessel, the strength or extent of the magnetic field produced by the electromagnet, the temperature of the fluid, or the like. The control unit may use the information acquired from the sensor to make decisions relating to the functioning of the apparatus, for example, to decide when to open or close a valve based on the volume of fluid in the vessel, or the residence time of the fluid in the vessel. In one example, the controller may be able to control the inlet valve to allow fluid into the vessel to a selected level, or a selected volume. The controller may then be able to open the outlet valve to expel the fluid from the vessel, for example after a selected period of time, or once a selected volume or weight of magnetically active particles have accumulated in the vessel, e.g. adjacent the electromagnet. In a further example, the controller may be able to control the inflow of fluid into one or more vessels of a multi-vessel apparatus, and/or may control the outflow of fluid from one or more vessels of a multi-vessel apparatus, e.g. the controller may ensure that the vessels are filled simultaneously, in a particular sequence or the like.

The vessel may configured to allow stacking or connecting of multiple vessels. For example, the vessel may comprise a male/female stacking or connecting arrangement, whereby each vessel comprises a male and female stacking structure and wherein the male stacking structure of one vessel may engage the female stacking structure of an adjacent vessel. In one example, a male stacking structure may be located towards the top surface of the vessel, while a female stacking structure may be located towards the base, or vice versa, thus facilitating vertical stacking of the vessels. Such stacking may permit ease of storage of the vessels, may, for example, allow the vessels to be transported more easily, or the like. The stacking structure may assist to improve the stability of multiple stacked vessels, may ensure preferable or correct alignment of multiple stacked vessels, or the like.

The electromagnet may be located adjacent and/or out with the vessel to ensure that the vessel is located within the magnetic field of the electromagnet in use. In one example, the electromagnet may be located beneath the vessel. Such placement of the electromagnet may induce a magnetic field that is strongest towards the base of the vessel. Having the magnetic field induced strongest towards the base of the vessel may allow the weight of the particles may further assist to retain the magnetically active or ferrous particles in the vessel.

At least some, or a majority, or all of the vessel may be located or locatable within the magnetic field. Having the vessel located entirely in the magnetic field may ensure that magnetically active or ferrous particles throughout the entire vessel are captured in the magnetic field and therefore retained in the vessel. Having the vessel partially located the magnetic field may encourage the magnetically active or ferrous particles to be retained within the section of the vessel e.g. having the part or end of the vessel furthest from the fluid outlet located in the magnetic field may encourage the magnetically active or ferrous particles to be retained far from the fluid outlet, which may reduce the likelihood of the fluid outlet becoming blocked by magnetically active or ferrous particles. The part of the vessel that is located within the magnetic field may be determined by the placement of the vessel relative to the electromagnet, the strength of the electromagnet and/or the material of the vessel, for example the part of the vessel nearest the electromagnet may comprise a more magnetically permeable material than other sections of the vessel. The skilled person will appreciate that there are many factors that may affect the strength of the magnetic field throughout the vessel.

The apparatus may comprise a support structure for supporting the vessel. The support structure may facilitate removal of the vessel from the apparatus. For example, the support structure may engage with the vessel to stabilise the vessel in use. The support structure may engage with the vessel via an engagement edge or surface such as a lip, groove, flange or the like. The support structure may facilitate removal of the vessel from the apparatus via lifting without the need to detach the vessel from the support structure, e.g. by unscrewing or unbolting.

The support structure may facilitate alignment of the vessel in the apparatus. For example the support structure may facilitate alignment of the fluid inlet and fluid outlet of the vessel with a corresponding inflow and outflow conduit. The support structure may facilitate alignment of the vessel with the electromagnet, to assist in correctly or preferably locating the vessel in the magnetic field.

The support structure may permit the stacking and/or horizontal alignment of at least two vessels. For example, the support structure may contain multiple interfaces with which to engage each separate vessel.

The support structure may be a similar or complementary shape to the vessel, or may be specifically shaped relative to the shape of the vessel, to facilitate reception and support of the vessel by the support structure. For example, where the vessel is cuboid shaped, the support structure may also be cuboid shaped. The shape of the support structure may be configured to maximise surface contact between the support structure and the vessel. Increased surface contact between the support structure and the vessel may facilitate improved structural support and improved induction of the magnetic field throughout the vessel, for example.

The support structure may comprise a base and a side wall, for example at least one side wall. Alternatively, the support structure may comprise only an at least one side wall. The support structure may have an open-top structure.

The support structure may be permanently installed in the apparatus.

Engagement of the vessel with the support structure may increase the structural integrity and strength of the vessel, for example, to permit the vessel to hold a larger volume of fluid. In one example, the vessel may require increased structural integrity when engaged with the support structure to allow the vessel to contain the volume and weight of fluid combined with magnetically active or ferrous particles. The fluid may be expelled from the vessel before removal from the apparatus, such that upon removal the load held by the vessel and the structural requirements of the vessel are reduced.

The electromagnet may form or define part of the support structure. By providing the electromagnet as part of the support structure, the electromagnet may be placed preferentially closer to the vessel. For example, the electromagnet may form, or be formed on, the base of the support structure. Alternatively or additionally, the electromagnet may comprise or define a side wall or portion of a side wall of the support structure. The electromagnet may be shaped to follow the shape of the vessel to maximise the area of surface contact between the vessel and the electromagnet. This configuration may permit the apparatus to be constructed more easily, may permit more efficient manufacture of the apparatus, and/or may permit a larger degree of control over the magnetic field in the vessel.

The apparatus may comprise a secondary means for removing particles from the fluid. In one example, the secondary means may be or comprise a magnetic system, which may comprise at least one or a plurality of magnetic rods or members, which may be or comprise electromagnetic rods or members, or permanent magnetic rods or members. The fluid may pass through the secondary means only after it has passed through the vessel. As such, the secondary means (e.g. the magnetic rods) may be located at the fluid outlet, or at a location downstream of the fluid outlet. The secondary means (e.g. magnetic rods) may assist to remove particles from the fluid not removed during the residency of the fluid in the vessel. As such, the use of the secondary means may assist to purify the fluid, and/or rid the fluid of magnetically active or ferrous particles. The use of the secondary means (e.g. the magnetic rods) may complement the use of the vessel with the electromagnet, as the vessel with the electromagnet may more easily remove large magnetically active or ferrous particles from the fluid, whereas the secondary means may more easily remove smaller particles from the fluid. As such, both the secondary means and the vessel may work together to produce a fluid having a lower concentration of magnetically active or ferrous particles, than each could produce individually. The secondary means may be capable of being turned on/off or being activated and deactivated, for example, in the case where the secondary means comprises electromagnetic rod members.

The secondary means may be or comprise a strainer or mesh. In such an example, particles may be removed from the fluid on a size exclusion basis, regardless of their magnetic properties.

The vessel may comprise a base and at least one wall protruding from the base. In one example, the vessel may comprise four side walls. At least one side wall may be removable. The vessel may have an open-top structure. The vessel may comprise more than one side wall, each side wall having the same height, or alternatively each side wall may have a different height.

The vessel may define the one or more fluid port. For example, the vessel may define the fluid inlet. For example, the vessel may define the fluid inlet in a side wall thereof. Placement of the fluid inlet in the side wall of the vessel may reduce the likelihood of the fluid inlet becoming blocked by magnetic and other particles resident in the vessel relative to placement in the base, for example. The fluid inlet may be located at or near the top of the side wall of the vessel, which may reduce or further reduce the likelihood of the fluid inlet becoming blocked by magnetic and other particles resident in the vessel, and/or may facilitate an even distribution of magnetically active or ferrous particles in the vessel. The fluid inlet may be located at or near the bottom of the side wall of the vessel, which may reduce the risk of the fluid splashing or unpredictably flowing out of the vessel upon entry of the fluid into the vessel. The fluid inlet may be located towards the centre of the side wall, thereby striking a balance between the aforementioned configurations.

The vessel may comprise multiple fluid inlets. For example, the vessel may comprise multiple fluid inlets in one side wall, positioned at different heights. Alternatively, the vessel may comprise multiple fluid inlets positioned on different side walls and/or positioned on the base of the vessel.

The vessel may define the fluid outlet. For example, the vessel may define the fluid outlet in a side wall of the vessel. Location of the fluid outlet in the side wall of the vessel may reduce the likelihood of the fluid outlet becoming blocked by magnetically active or ferrous particles resident in the vessel. The fluid outlet may be located at or near the bottom of the side wall of the vessel to assist with the expulsion of fluid from the vessel e.g. to allow fluid to completely drain from the vessel. The fluid outlet may have a location on the side wall raised from the bottom, to reduce the likelihood of the fluid outlet becoming blocked by magnetic and other particles that have settled at the bottom of the vessel. The placement of the fluid outlet in the vessel may be relative to the placement of the electromagnet, or the strength of the magnetic field. The fluid outlet may be located away from the electromagnet, such that upon operation of the electromagnet the outlet remains free from magnetically active or ferrous particles. For example, where the electromagnet is located on, or in contact with the base of the vessel, or where the induced magnetic field is strongest on the base of the vessel, the fluid outlet may be located on a side wall of the vessel. The opposite may also be the case, i.e. where the electromagnet is located on, or in contact with a side wall of the vessel, or where the induced magnetic field is strongest on a side wall of the vessel, the fluid outlet may be located on the base or on another side wall of the vessel.

Where the vessel has an open-topped structure, the open-top may define the fluid inlet and/or the fluid outlet. In some examples, the fluid outlet may be the same as the fluid inlet. The open-top of the vessel may provide such a combined fluid inlet and outlet.

The vessel may comprise multiple fluid outlets. For example, the vessel may comprise multiple fluid outlets in one side wall, positioned at different heights. Alternatively, the vessel may comprise multiple fluid outlets positioned on different side walls and/or positioned on the base of the vessel.

The apparatus may comprise a bypass arrangement. Such a bypass arrangement may permit fluid to bypass a part of the apparatus. For example, the bypass arrangement may permit the fluid to bypass the vessel, or at least one of the vessels of the apparatus. The bypass arrangement may permit a user to use the apparatus for fluids not requiring passage through the vessel, or one of the vessels. For example, the apparatus may intermittently experience flow of fluids not containing magnetically active or ferrous particles.

The vessel may be made from any appropriate material. In one example, the vessel may comprise a metal, for example steel, aluminium, or the like. The vessel may comprise a non-metal material, for example a plastic. The vessel may comprise a mixture of metal and non-metal materials.

A further aspect of the invention relates to a method for operating an apparatus for removing magnetically active or ferrous particles, the method comprising:
introducing a fluid containing swarf into at least one vessel;
operating an electromagnet to produce a magnetic field within the vessel to act on the magnetically active or ferrous particles;
removing the fluid from the vessel;
removing the swarf from the vessel, separately from the fluid.

Another aspect relates to a method for operating an apparatus for removing magnetically active or ferrous particles, the method comprising:
introducing a fluid containing swarf into at least one vessel, the at least one vessel being removable from the apparatus;
operating an electromagnet to produce a magnetic field within the vessel to act on the magnetically active or ferrous particles;
removing the fluid from the vessel;
removing the swarf from the vessel, separately from the fluid.

### BRIEF DESCRIPTION

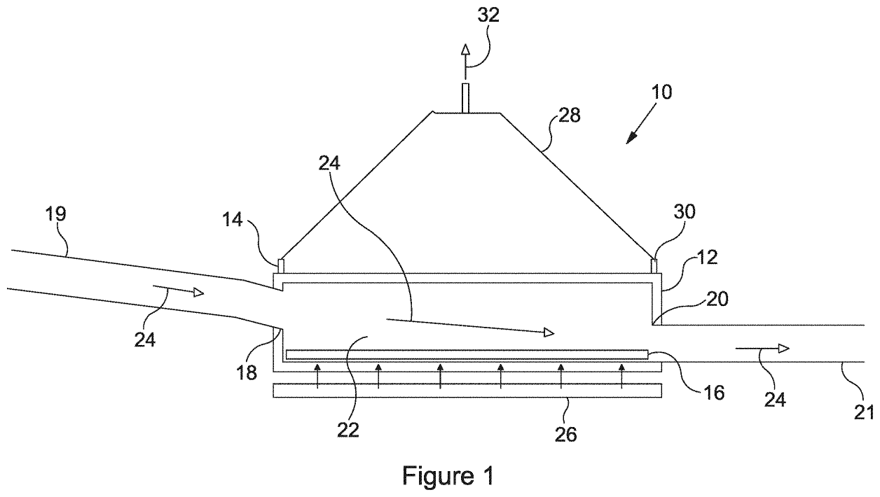

FIG. 1 is a sectional view illustrating fluid flow through an example of an apparatus.

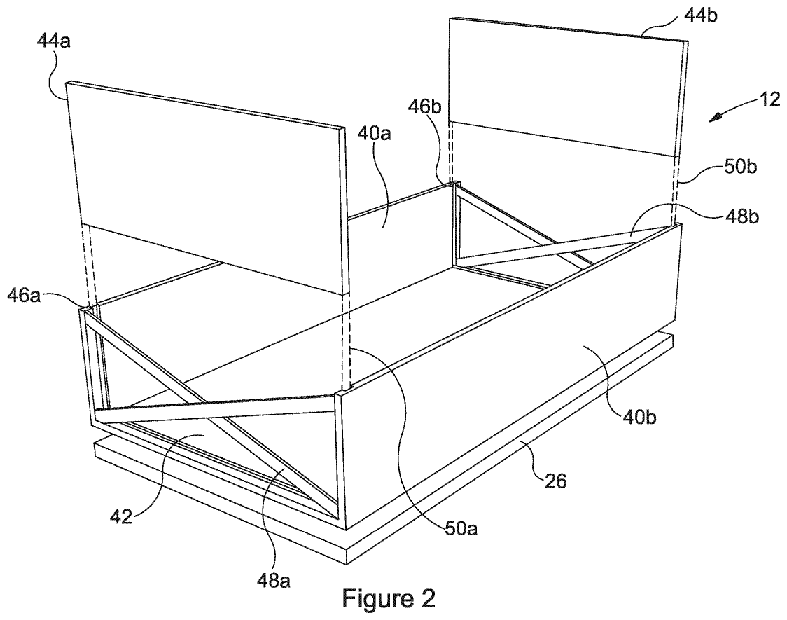

FIG. 2 is a schematic illustration of a support structure.

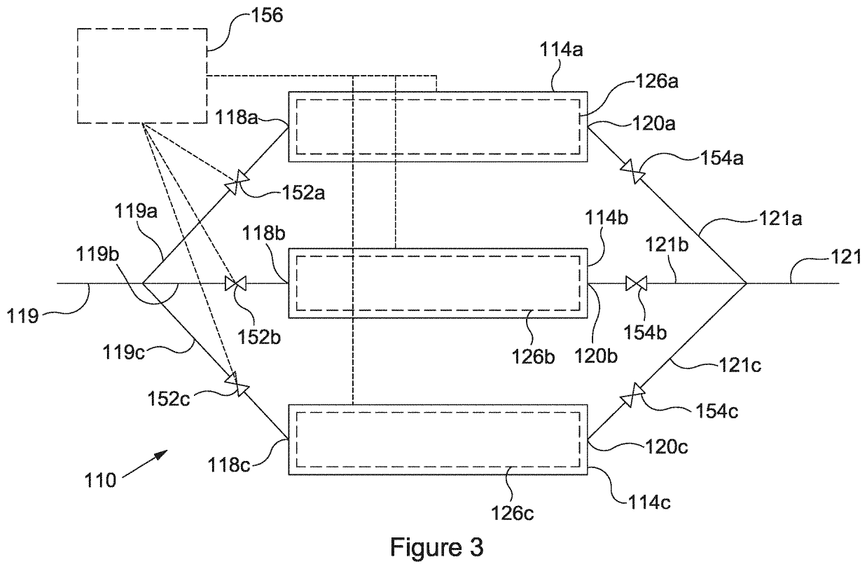

FIG. 3 is a diagrammatic illustration of an apparatus including multiple vessels.

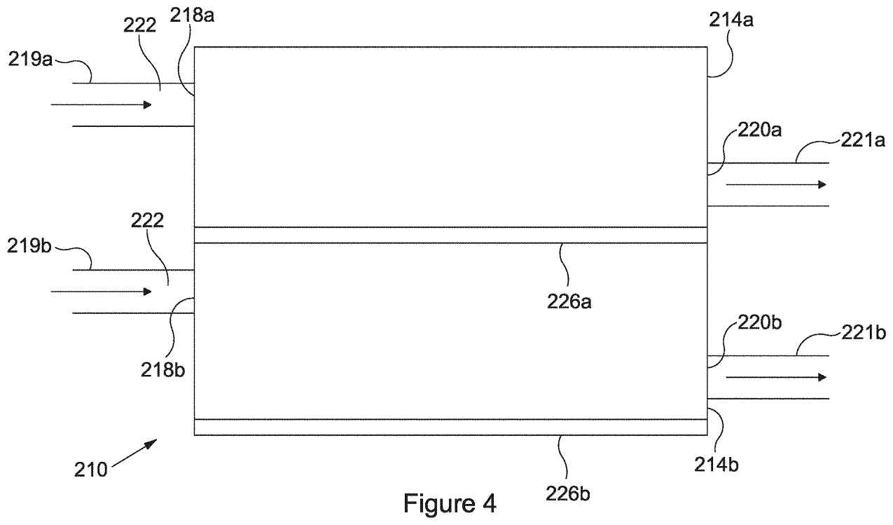

FIG. 4 is a side view of stacked vessels of an example of an apparatus.

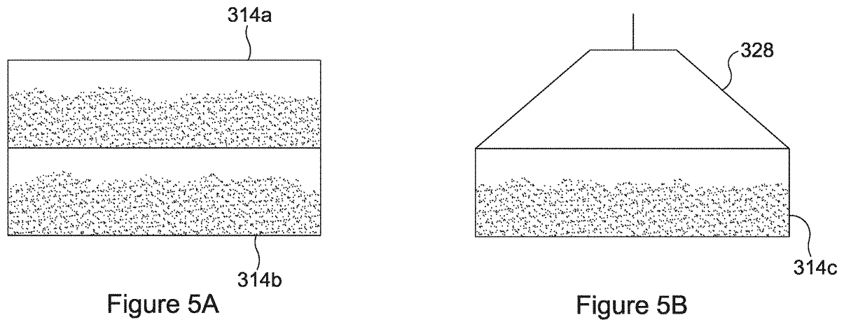

FIG. 5A is a diagrammatic sectional view of two stacked vessels.

FIG. 5B is a diagrammatic sectional view of a vessel attached to a lifting apparatus.

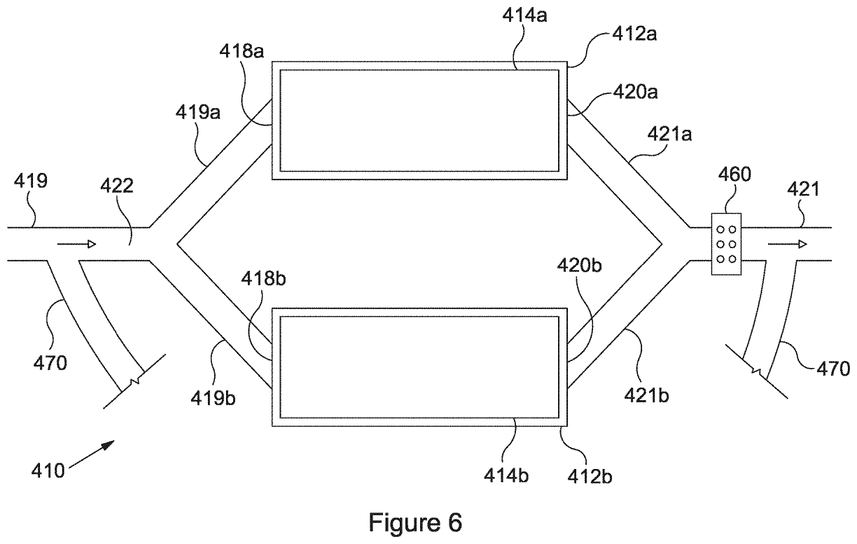

FIG. 6 is a plan view of an example of an apparatus including multiple vessels.

### DETAILED DESCRIPTION

FIG. 1 illustrates a cross-sectional side view of an example of an apparatus 10 for removing magnetically active or ferrous particles from a fluid. The apparatus 10 comprises a support structure 12 and a vessel 14, the vessel 14 being supported by the support structure 12. The vessel 14 has an open-top cuboid shape, having a base and four side walls, while the support structure 12 has a similarly open-top cuboid shape, and in this example a layer of magnetically active or ferrous particles is shown to have formed on the base of the vessel 14.

A treated fluid 22 enters and exits the vessel 14 via fluid ports 18, 20. In this example, the fluid 22 enters via a fluid inlet 18 and exits the vessel via a fluid outlet 20. The treated fluid 22 is supplied to the vessel 14 via inlet pipe 19, and exits the vessel 14 via outlet pipe 21. Both the fluid inlet 18 and the fluid outlet 20 are defined by the vessel 14 and the support structure 12, and are each located in a side wall thereof. In this example, the fluid inlet 18 is located in an opposite side wall to the fluid outlet 20. The fluid inlet 18 is located towards the top of a side wall of the vessel 14 and support structure 12, while the fluid outlet 20 is located towards the base of a side wall of the vessel 14 and support structure 12. Such a configuration of the fluid inlet 18 and fluid outlet 20 may assist to more evenly disperse the magnetically active or ferrous particles 16 within the vessel 14 upon entry, and reduce the likelihood of the fluid inlet 18 becoming blocked by a build-up of particles 16 on the base of the vessel 14. The fluid outlet 20 being located on the base of the vessel may enable the vessel 14 to be fully drained of the treated fluid 22. In other embodiments, the fluid inlet 18 and fluid outlet 20 may be defined in the same side wall of the vessel 14 and support structure 12, or may be defined on adjacent side walls of the vessel 14 and support structure 12. In further embodiments, multiple fluid inlets 18 and/or fluid outlets 20 may be defined in the side wall or walls of the vessel 14 and support structure 18, or one or both of the fluid inlet 18 or fluid outlet 20 may be defined in the base of the vessel 14 and support structure 12.

Alternatively, the vessel 14 and support structure 12 need not comprise a fluid inlet 18 and/or fluid outlet 20 in a side wall and/or base of the vessel 14 and support structure 12. Instead, the fluid may enter and/or exit the vessel via the open-top of the vessel and support structure. Therefore, in such an embodiment, no inlet and/or outlet would be required in the base or side walls of the vessel 14 and support structure 12.

An electromagnet 26 is located beneath the base of the vessel 14. The electromagnet 26 can be activated to capture and retain magnetically active or ferrous particles 16 initially entrained in treated fluid 22 in the vessel 14. As the electromagnet 26 is located beneath the base of the vessel 14, the magnetically active or ferrous particles 16 are held on or near the base of the vessel 14. As the remainder of the components of the treated fluid 22 are not magnetically active, these components are not affected by the magnetic field of the electromagnet 26 and are allowed to flow out of the vessel 14 via the fluid outlet 20.

In other embodiments, the electromagnet 26 may be located, or partially located, adjacent a side wall of the vessel 14. In such embodiments, the magnetically active or ferrous particles 16 may be held at or near a particular section of the vessel 14, for example the particles 16 may be held at or near one side of the base of the vessel 14 e.g. the side furthest from the fluid outlet, and/or on one or multiple side walls of the vessel 14.

A lifting apparatus 28 is attached to flanges 30 on the vessel 14. The flanges 30 are located around the rim of the vessel 14, and are attachable to the lifting apparatus 28 to enable the vessel 14 to be lifted from the support structure 12 in the upwards direction of arrow 32. Once removed from the support structure 12, the magnetically active or ferrous particles 16 may be more easily removed from the vessel 14, and the vessel 14 may be more easily cleaned, for example.

FIG. 2 is a schematic illustration of a support structure 12. As in FIG. 1, the support structure 12 has an open-top cuboid shape, comprising a base 42 and four side walls. In this example, the two major side walls 40a, 40b are rigidly attached to the base 42, while the minor side walls 44a, 44b are removable. The support structure 12 is equipped with slots 46a, 46b to support removable side walls 44a, 44b, whilst allowing them to be easily removed from the support structure. The support structure 12 also comprises support ties 48a, 48b to allow the support structure 12 to hold its shape when the removable side walls 44a, 44b have been removed. FIG. 2 shows the removable walls 44a, 44b, in the removed configuration and indicates, in broken outline, a path 50a, 50b, through which the removable walls 44a, 44b may be moved to engage with the support structure 12.

Although not shown in FIG. 2, any of the side walls or base of the support structure 12 may comprise a fluid inlet and/or fluid outlet, as previously explained with reference to FIG. 1. Having removable side walls 44a, 44b, may permit the replacement of one side wall with another, having varying configurations of fluid inlet and/or fluid outlet, for example. In FIG. 2, a removable wall having no fluid inlet or fluid outlet is shown.

However, at least one of the removable walls 44a, 44b, may be replaced with a removable wall having at least one fluid inlet and/or fluid outlet, which may be positioned as required.

In this example, as with FIG. 1, the electromagnet 26 is positioned beneath the base 42 of the support structure 12.

FIG. 3 is a diagrammatic illustration of an apparatus 110 comprising multiple vessels 114a, 114b, 114c arranged in parallel. FIG. 3 comprises many similar components to FIGS. 1 and 2, and as such the reference numerals are the same, but augmented by 100.

Each of the vessels is supported in a corresponding support structure (not shown), and beneath each vessel 114a-c is located a corresponding electromagnet 126a, 126b, 126c. Treated fluid (not shown) flows into each of the vessels 114a-c via fluid inlet 118a, 118b, 118c, and out of the vessels via fluid outlet 120a, 120b, 120c.

In FIG. 3, fluid flow into and out of the vessels 114a-c can be controlled via operation of inlet valves 152a, 152b, 152c, and outlet valves 154a, 154b, 154c.

A control unit 156 may be used to control operation of the valves 152a-c, 154a-c and the electromagnets 126a-c (although it should be noted that no connection between the control unit 156 and the valves 154a-c is shown in FIG. 3 for clarity).

As with FIG. 1, the fluid is delivered to the vessels 114a-c via inlet pipes 119a-c, and drained from the vessels 114a-c via outlet pipes 121a-c. Shown in FIG. 3, the inlet pipes start out as a common inlet pipe 119, and branch out into separate inlet pipes 119a-c. Outlet pipes 121a-c begin as three separate branches and converge into one common outlet pipe 121.

In use, treated fluid flows along inlet pipe 119 and towards vessels 114a-c. The control unit is able to operate inlet valves 152a-c to divert the flow of treated fluid into each of the vessels 114a-c by selectively opening or closing each of the inlet valves 152a-c. The control unit may be able to configure each of the vessels 114a-c to receive treated fluid at the same time, or may configure the vessels to be filled sequentially or alternately.

When an inlet valve 152a-c is open and fluid is flowing into the respective vessel 114a-c, the outlet valve 154a-c is closed such that the fluid is held in the vessel. Once the fluid enters the vessel 114a-c, the corresponding electromagnet 126a-c is operated to capture magnetically active or ferrous particles within the fluid, so that the magnetically active or ferrous particles are attracted towards the electromagnet 126a-c and are retained in the vessel 114a-c.

The treated fluid is then held in the vessel 114a-c for a predetermined residence time e.g. 10 minutes, 15 minutes, 20 minutes, or the like, after which the outlet valve 154a-c is opened and the fluid allowed to flow from the vessel 114a-c. The fluid flowing from the vessel 114a-c is free from, or substantially free from, magnetically active or ferrous particles.

As FIG. 3 shows a plan view of the vessels 114a-c, it is not possible to show at which elevation each vessel 114a-c each is located. However, it is possible to locate each vessel 114a-c at the same or different elevations.

Although FIG. 3 is shown as having three vessels 114a-c, the skilled person would appreciate that an embodiment comprising more or fewer vessels would be possible. Further, although only one source of fluid is provided at inlet pipe 119, it should be appreciated that there may be multiple sources of fluid. Similarly, although only one outlet pipe 121 is shown, there may be multiple outlet pipes.

FIG. 4 is a side view of stacked vessels 214a, 214b in an example of an apparatus 210. The vessels 214a, 214b, shown are substantially similar to that shown in FIG. 1. As such the reference numerals are the same, but augmented by 200.

For clarity, in this example the support structure is omitted, however it should be understood that a support structure may be provided around the vessels 214a, 214b. FIG. 4 shows an apparatus 210 having two stacked vessels 214a, 214b. Although not shown, the vessels 214a, 214b, comprise a stacking arrangement to allow the vessels 214a, 214b to be stacked, while remaining stable. The stacking arrangement may be or comprise, for example, a male/female component, allowing the base of vessel 214a to engage the top of vessel 214b.

Inlet pipe 219a, 219b allows fluid to flow into each vessel via inlet 218a, 218b, and out of each vessel via fluid outlet 220a, 220b. Each vessel comprises an electromagnet 226a, 226b located beneath the base of the vessel 214a, 214b.

The apparatus 210 is operated in a similar manner to the apparatus in the previous Figures.

Although two vessels 214a, 214b are shown in FIG. 4, the skilled person would appreciate that more than two vessels may be stacked an operated as in FIG. 4.

Further, the vessels 214a, 214b are described as comprising a stacking apparatus to allow each of the vessels a stable engagement, permitting a stable stacking of the vessels. However, where a support structure is provided, a vessel may comprise a stacking arrangement permitting engagement with the support structure, rather than with a second vessel.

FIGS. 5A and 5B show side views of vessels 314a, 314b, 314c removed from an apparatus. The vessels shown are substantially similar to those shown in FIG. 1, and as such the reference numerals used are the same, but augmented by 300. Each of the vessels 314a-c is filled with magnetically active or ferrous particles removed from a treated fluid.

FIG. 5A shows two vessels 314a, 314b, stacked, similar to as shown in FIG. 4. Stacking the vessels while filled with magnetically active or ferrous particles may allow the vessels to be stored, while awaiting emptying of magnetically active or ferrous particles or cleaning.

FIG. 5B illustrates a vessel 314c filled with magnetically active or ferrous particles and attached to a lifting apparatus 328. A lifting apparatus is used to lift the vessels from the apparatus, and may also be used to stack the vessels.

FIG. 6 further illustrates an example of an apparatus 410. The apparatus shown in FIG. 6 is substantially similar to those shown in the previous Figures, as such the reference numerals used are the same, but incremented by 400.

The apparatus 410 comprises two vessels 414a, 414b, and each are contained in a support structure 412a, 412b. The inlet pipe 419 separates into two branches 419a, 419b to provide a treated fluid 422 to each vessel 414a, 414b, via fluid inlet 418a, 418b. As in FIG. 3, the vessels 414a, 414b are located in parallel.

Each vessel comprises a corresponding fluid outlet 420a, 420b leading to outlet pipe 421a, 421b. In this embodiment, at the section where the outlet pipes 421a, 421b converge into one single outlet pipe 421, there is located a secondary means 460 for removing magnetically active or ferrous particles from the treated fluid 422. In this embodiment, the secondary means is an electromagnetic rod system, although the skilled person will understand that any appropriate means or apparatus for removing particles from a fluid may be appropriate such as a strainer e.g. a mesh strainer, shaker etc. The secondary means 460 is used to remove particles from the treated fluid 422 that were not removed during residence of the treated fluid 422 in the vessels 414a, 414b. Failure to remove such particles from the fluid during residence in the vessels 414a, 414b may be due to the particles being too small, for example, for due to an overflow of particles in the vessel.

The apparatus 410 of FIG. 6 further comprises a bypass arrangement 470. The bypass arrangement 470 may be used when it is required to flow fluid from the inlet pipe 419 to the outlet pipe 421 without passage through the vessels 414a, 414b. This may be useful when, for example, the fluid does not contain any magnetically active or ferrous particles.

1. A swarf removal apparatus for removing magnetically active particles from a fluid received from a wellbore, the apparatus comprising:
at least one vessel for comprising a fluid inlet to receive fluid from the wellbore comprising magnetically active or ferrous particles comprising at least one of: drill swarf, steel and/or debris from a pipe, tubular, wellbore casing and/or other metallic wellbore component or content and a fluid outlet to expel fluid from the vessel;
at least one electromagnet operable to produce a magnetic field within the vessel to act on the magnetically active or ferrous particles in use; and
a support structure for supporting the vessel;
wherein the at least one vessel is removable from the apparatus; and
wherein the electromagnet forms part of the support structure.

2. An apparatus according to claim 1, comprising at least two vessels.

3. An apparatus according to claim 2, wherein each of the at least two vessels comprises a separate electromagnet.

4. An apparatus according to claim 3, wherein each of the separate electromagnets are operable at the same time.

5. An apparatus according to claim 3, wherein each of the separate electromagnets are operable alternately.

6. An apparatus according to claim 2, wherein the at least two vessels are located side-by-side.

7. An apparatus according to claim 2, wherein the at least two vessels are located at the same vertical elevation.

8. An apparatus according to claim 1, wherein the at least one electromagnet is located below the at least one vessel.

9. An apparatus according to claim 1, wherein the support structure is permanently installed in the apparatus.

10. An apparatus according to claim 1, comprising a secondary means for removing particles from a fluid.

11. An apparatus according to claim 10, wherein the secondary means is located at the fluid outlet.

12. An apparatus according to claim 1, wherein the vessel comprises a base and at least one side wall protruding from the base.

13. An apparatus according to claim 12, wherein the vessel comprises four side walls.

14. An apparatus according to claim 12, wherein at least one side wall of the vessel is removable.

15. An apparatus according to claim 12, wherein the vessel defines the fluid inlet on a side wall of the vessel.

16. An apparatus according to claim 12, wherein the vessel defines the fluid outlet on a side wall of the vessel.

17. An apparatus according to claim 1, comprising a bypass arrangement.

18. An apparatus according to claim 1, wherein the at least one vessel comprises a metal material.

19. An apparatus according to claim 1, wherein the at least one vessel comprises steel material.

20. A method for operating a swarf removal apparatus for removing magnetically active or ferrous particles, the method comprising:
introducing a fluid received from a wellbore containing swarf into at least one vessel of the apparatus via a fluid inlet, the at least one vessel being removable from the apparatus and further comprising a fluid outlet to expel fluid;
wherein the apparatus further comprises a support structure for supporting the vessel and at least one electromagnet operable to produce a magnetic field within the vessel, the at least one electromagnet forming part of the support structure;
operating an electromagnet to produce a magnetic field within the vessel to act on the magnetically active or ferrous particles;
removing the fluid from the vessel through the fluid outlet;
removing the swarf from the vessel, separately from the fluid.
